(19) United States
(12) Patent Application Publication
(10) Pub. No.: US 2025/0347796 A1
(43) Pub. Date: Nov. 13, 2025

(54) OCCUPANT DETECTION WITH REDUCED MEMORY SPACE

(71) Applicant: HELLA GMBH & CO. KGAA, Lippstadt (DE)

(72) Inventors: Orlando Ciricosta, Berlin (DE); Etienne Costa-Patry, Berlin (DE); Esakki Ponraj Esakkimuthu, Berlin (DE)

(21) Appl. No.: 19/279,015

(22) Filed: Jul. 24, 2025

Related U.S. Application Data
(63) Continuation of application No. PCT/EP2024/050067, filed on Jan. 3, 2024.

(30) Foreign Application Priority Data
Jan. 26, 2023 (DE) 102023101891.4

(51) Int. Cl. G01S 13/04; G01S 13/02; G01S 13/88

(52) U.S. Cl. CPC G01S 13/04; G01S 13/0209; G01S 13/886

(57) ABSTRACT

The present invention relates to a method for detecting an occupant of a motor vehicle. The method includes: sending a scanning signal into an interior of the motor vehicle by a UWB transmitting device; receiving the scanning signal by a UWB receiving device; forwarding the received scanning signal from the UWB receiving device as a data stream to an evaluation device; creating a first analysis statement by means of a first decision unit of the evaluation device by analyzing the data stream on the basis of a first decision criterion; creating a second analysis statement by means of a second decision unit of the evaluation device by analyzing the data stream on the basis of a second decision criterion; and generating a detection evaluation by a logic device of the evaluation device by combining the first analysis statement with the second analysis statement.

### CROSS-REFERENCE TO RELATED APPLICATIONS

The present application is a continuation of PCT/EP2024/050067, filed Jan. 3, 2024, which claims the benefit of German Patent Application No. 10-2023-101-891.4, filed Jan. 26, 2023, the disclosures of which are incorporated by reference in their entirety.

### FIELD OF THE INVENTION

The present invention relates to a method for operating a detection system for detecting an occupant of a motor vehicle. The invention also relates to a detection system for detecting an occupant of a motor vehicle, a computer program product, a computer-readable medium, and a motor vehicle.

### BACKGROUND OF THE INVENTION

Detection systems for motor vehicles for detecting occupants of the motor vehicle are known, which comprise pressure sensors that are arranged on the seat surfaces of seats of the motor vehicle and are designed to detect pressure acting on the seat surface. These detection systems are designed to determine the occupancy of the seat when pressure is detected that exceeds a predefined minimum pressure. Nevertheless, these systems are not suitable for reliably distinguishing between a person, an animal, and a piece of luggage.

More modern and complex detection systems comprise ultra-wideband (UWB) sensor devices that are arranged in the interior of the motor vehicle and are designed to emit an ultra-wideband signal into the interior and receive a reflection of the signal. Occupants or objects located in the interior of the motor vehicle cause interference to the emitted signal, which affects the received signal and can therefore be measured. The received signals are stored as a reflection image and compared with reference images by an evaluation device, wherein the reference images represent different disturbances caused by occupants and objects of different sizes in the interior. The similarity between the reflection images and the reference images enables the evaluation device to make statements about the occupancy of the interior of the motor vehicle. Due to the number and size of the reflection images to be analyzed, such a detection system requires a relatively large working memory of sometimes more than 500 KB. This increases the cost of such a detection system.

### SUMMARY OF THE INVENTION

A first aspect of the invention relates to a method for operating a detection system for detecting an occupant of a motor vehicle. The method includes: sending a scanning signal into an interior of the motor vehicle by a UWB transmitting device of the detection system; receiving the scanning signal by a UWB receiving device of the detection system; forwarding of the received scanning signal from the UWB receiving device as a data stream to an evaluation device of the detection system; creating a first analysis statement by means of a first decision unit of the evaluation device by analyzing the data stream on the basis of a first decision criterion; creating a second analysis statement by means of a second decision unit of the evaluation device by analyzing the data stream on the basis of a second decision criterion; and generating a detection evaluation by a logic device of the evaluation device by combining the first analysis statement with the second analysis statement.

First, the interior of the motor vehicle is subjected to the scanning signal by the UWB transmitting device of the detection system. The UWB transmitting device is preferably designed as part of a UWB sensor device of the detection system. The scanning signal of the UWB transmitting device is in the ultra-wideband (UWB) range and preferably has a range of at least 1 m, more preferably at least 2 m. The range of the scanning signal is understood to be a distance from the UWB transmitting device and the UWB receiving device at which reliable detection of the occupant is still ensured. The range depends on the design and transmission power of the UWB transmitting device. The scanning signal is preferably sent as a function of predefined triggering factors, such as starting or switching off an engine of the motor vehicle, activating or deactivating an on-board power supply system of the motor vehicle, opening or closing a door of the motor vehicle, locking or unlocking the motor vehicle, or the like. Preferably, the scanning signal is sent as a short pulse, for example, over 100 milliseconds, 1 second, or the like. It is preferable that the scanning signal, in particular when the motor vehicle is switched off, does not occur over an extended period of time, such as continuously, for more than 10 seconds, or the like, in order to trigger a possible alarm signal in a timely manner.

The transmitted scanning signal is influenced by occupants and objects located in the interior of the motor vehicle. This influence therefore has a direct effect on the reception of the scanning signal by the UWB receiving device, as the influenced scanning signal is received in this process. The UWB receiving device is preferably designed as part of a UWB sensor device of the detection system.

The UWB receiving device forwards the received scanning signal, i.e. the scanning signal influenced by any occupants and objects in the interior, as a data stream to the evaluation device. The forwarding is preferably carried out via a bus (e.g. Ethernet or CAN) of the detection system. In this context, forwarding as a data stream is preferably understood to mean that the received scanning signal, which can, for example, be represented as an image comprising several lines, is transmitted successively, for example continuously line by line of the image.

The first decision unit of the evaluation device analyzes the data stream using the first decision criterion and creates the first analysis statement therefrom. The first decision unit preferably comprises artificial intelligence or at least an algorithm capable of learning. The first decision criterion is directed at one or more aspects of an occupant or object in the interior of the motor vehicle. The first decision unit is designed to analyze the data stream while the data stream is being received using the first decision criterion and thus to generate the first analysis statement. Preferably, the first decision unit performs a continuous or intermittent check of the first analysis statement based on the data stream and the first decision criterion. An aspect of an occupant or object may, for example, relate to size, shape, position, movement, or the like. The first analysis statement preferably corresponds to a first characteristic feature of the occupant or object.

The second decision unit of the evaluation device analyzes the data stream using the second decision criterion and creates the second analysis statement therefrom. The second decision unit preferably comprises artificial intelligence or at least an algorithm capable of learning. The second decision criterion is preferably different from the first decision criterion. The second decision criterion is directed at one or more aspects of an occupant or object in the interior of the motor vehicle. The second decision unit is designed to analyze the data stream while the data stream is being received using the second decision criterion and thus to generate the second analysis statement. The second analysis statement preferably corresponds to a second characteristic feature of the occupant or object. Preferably, the second decision unit performs a continuous or intermittent check of the second analysis statement using the data stream and the second decision criterion. Preferably, the data stream is analyzed simultaneously by the first decision unit and the second decision unit.

The data stream is preferably analyzed by the first decision unit until the first analysis statement satisfies a predefined first statement reliability criterion, for example, that a change, in particular a relevant change, to the first analysis statement is no longer to be expected and further analysis of the data stream with regard to the first decision criterion is therefore no longer necessary. Accordingly, the data stream is preferably analyzed by the second decision unit until the second analysis statement satisfies a predetermined second statement reliability criterion, for example, that a change, in particular a relevant change, to the second analysis statement is no longer to be expected and further analysis of the data stream with regard to the second decision criterion is therefore no longer necessary.

The first analysis statement and the second analysis statement are provided, preferably simultaneously, to the logic device of the evaluation device. The logic device preferably comprises artificial intelligence or at least an algorithm capable of learning. The logic device combines the first analysis statement with the second analysis statement and generates the detection evaluation therefrom. This can be done, for example, in such a way that the logic device compares the characteristic features provided by the decision units with known feature combinations, and uses this to determine the presence or a position of an occupant or object or the like as a detection evaluation.

The method is preferably carried out in such a way that a plurality of seats of the motor vehicle, for example, the front seats and/or the seats of a second row of seats and/or the seats of any third row of seats, are monitored. For example, this can be done successively for each seat individually, for each row of seats or for all seats simultaneously. The first analysis statement preferably always refers to a specific seat, so that if there is a plurality of seats, a first analysis statement valid for this specific seat is created for each seat. The same applies to the second analysis statement and the detection evaluation.

Preferably, the detection system is coupled to a display of the motor vehicle, so that the detection evaluation or a result derived from the detection evaluation, such as the detection of a person in a rear seat with a belt system in an unbuckled state, can be shown on the display. Further preferably, the detection system is connected to other functions of the motor vehicle, such as an airbag, so that an airbag can be automatically deactivated upon detection of a baby, raised legs, luggage or the like.

A method according to the invention for operating a detection system for detecting an occupant of a motor vehicle has the advantage over conventional methods in that, using simple means and in a cost-effective manner, a fast and reliable detection of an occupant or object in the interior of the motor vehicle is ensured. By using the data stream to create the first analysis statement and the second analysis statement, it is no longer necessary to store an overall detection image so the detection system used to perform the method requires considerably less memory than conventional detection systems. Furthermore, by creating analysis statements directly from the data stream, the time between the start of creating the analysis statements and generating a valid detection evaluation can be further reduced.

According to a preferred further development of the invention, it may be provided in a method that the first analysis statement and/or the second analysis statement are designed as binary analysis statements. A binary analysis statement is understood to be an analysis statement that can have two values, such as yes or no, black or white, greater than x or less than x, faster than y or slower than y, or the like. Creating and evaluating binary analysis statements is particularly advantageous for automated systems, such as the evaluation device, as it is easier to perform than analysis statements with more than two possible values. Thus, creating the first analysis statement, the second analysis statement, and generating the detection evaluation is facilitated. This has the advantage that, using simple means and in a cost-effective manner, a reliability in operating the detection system is improved, while the demands on the existing resources of the detection system are reduced.

According to the invention, it is preferred that the first analysis statement or the second analysis statement relates to the detection of a living being, the detection of a human being, or the detection of a child. Preferably, the first analysis statement relates to the detection of a living being and the second analysis statement relates to the detection of a child. It is further preferred that another, for example, third analysis statement relates to the detection of a human. This has the advantage that, using simple means and in a cost-effective manner, for example, the presence of a child not wearing a seatbelt or a pet as well as a child without an adult can be detected. By issuing a corresponding alarm, a driver of the motor vehicle who, for example, is just locking the vehicle can be made aware that there is still a child in the motor vehicle.

Further preferably, an alarm is issued by an alarm transmitter if the detection evaluation corresponds to a predefined detection result. Preferably, the alarm transmitter is designed as a component of the detection system. Alternatively, the alarm transmitter can also be designed as a component of another system of the motor vehicle, which is coupled to the detection system. The alarm transmitter can, for example, be designed as or comprise a piezo element, loudspeaker, lighting device, display device, or the like. The alarm can be issued, for example, as an alarm tone, voice message, light signal, a message via a cell phone, or the like. By issuing an alarm, the driver can be made aware of the whereabouts of a child or pet in the interior of the motor vehicle, for example, preventing the driver from accidentally leaving them behind in the motor vehicle. This has the advantage that, using simple means and in a cost-effective manner, it is possible to improve the benefits of the detection system for a user of the motor vehicle, such as a driver or passenger.

In a particularly preferred embodiment of the invention, a method may provide that the data stream is analyzed in such a way that the scanning signal is analyzed segment by segment. In the context of the invention, a segment-by-segment analysis of the scanning signal is understood to mean that a part of the data stream is first buffered and is only analyzed when a predetermined segment of the scanning signal results therefrom. For example, the segment can be designed as one or more lines of a scanning image of the interior of the motor vehicle. The segment of the scanning image is preferably less than 10%, more preferably less than 2%, and particularly preferably less than or equal to 0.5% of the entire scanning image. As an alternative to such segmented analysis, the data stream can also be analyzed directly on receipt. This has the advantage that, using simple means and in a cost-effective manner, a reliability of the generated detection evaluation is improved.

Preferably, analyzing the data stream is carried out continuously or intermittently. In the context of the invention, continuous analysis is understood to mean that preferably analyzing the data stream is carried out without interruptions. In the case of intermittent analysis, preferably only certain aspects of the data stream are analyzed, for example, sections that are expected to have a particularly high informative value for creating the first analysis statement and/or the second analysis statement. This has the advantage that, using simple means and in a cost-effective manner, an efficiency of operating the detection system can be improved.

According to a preferred embodiment of the invention, at least one third decision unit of the evaluation device creates at least one third analysis statement by analyzing the data stream on the basis of at least one third decision criterion, wherein the logic device generates the detection evaluation by combining the first analysis statement with the second analysis statement and the at least one third analysis statement. The third decision unit analyzes the data stream on the basis of the third decision criterion and creates the third analysis statement therefrom. Each further decision unit of the evaluation device analyzes the data stream on the basis of a further decision criterion and creates a corresponding further analysis statement therefrom. The logic device combines the created analysis statements, preferably all analysis statements created by the decision units of the evaluation device, and generates the detection evaluation therefrom. In this way, more aspects of the occupants and objects located in the interior of the motor vehicle can be taken into account. This has the advantage that, using simple means and in a cost-effective manner, a quality of the detection evaluation can be improved. Furthermore, by increasing the number of analysis statements, the time between the start of creating the analysis statements and generating a valid detection evaluation can be further reduced.

According to a second aspect of the invention, the object is achieved by a detection system for detecting an occupant of a motor vehicle. The detection system comprises a UWB transmitting device for transmitting a scanning signal into an interior of the motor vehicle, a UWB receiving device for receiving the scanning signal and for forwarding the received scanning signal as a data stream, and an evaluation device for receiving the data stream. The evaluation device comprises a first decision unit for creating a first analysis statement from the data stream in conjunction with a first decision criterion, a second decision unit for creating a second analysis statement from the data stream in conjunction with a second decision criterion, and a logic device for generating a detection evaluation by combining the first analysis statement with the second analysis statement.

Preferably, the evaluation device also comprises one or more further decision units, each of which is designed to create a further analysis statement from the data stream in conjunction with a further decision criterion.

The detection system according to the invention has all the advantages that have already been described for a method for operating a detection system for detecting an occupant of a motor vehicle according to the first aspect of the invention. Accordingly, the detection system according to the invention has the advantage over conventional detection systems in that, using simple means and in a cost-effective manner, a fast and reliable detection of an occupant or object in the interior of the motor vehicle is ensured. By designing the decision units to use the data stream to generate the first analysis statement and the second analysis statement, it is no longer necessary to store an overall detection image, so that the detection system requires considerably less memory than conventional detection systems. Furthermore, by creating analysis statements directly from the data stream, the time between the start of creating the analysis statements and generating a valid detection evaluation can be further reduced.

Particularly preferably, the detection system is designed to carry out a method for operating a detection system for detecting an occupant of a motor vehicle according to the first aspect of the invention.

According to the invention, it is preferred that the evaluation device comprises a memory device for storing a segment of the data stream and/or analysis statements, wherein the memory device has a working memory size (RAM) of less than 100 kB, preferably less than 10 kB. Thus, the memory device differs considerably from memory devices of conventional detection systems with UWB sensor technology, which often have memory sizes of 500 KB (RAM) or more, and are therefore very cost-intensive. This has the advantage that, using simple means and in a cost-effective manner, the consumption of resources in the manufacture of the detection system can be significantly reduced compared to conventional detection systems. This also reduces manufacturing costs.

Further preferably, the first decision unit and the second decision unit are connected in parallel with respect to the data stream. Here, it is preferred that any third decision unit, any fourth decision unit, and any further decision units are connected in parallel with the first decision unit and the second decision unit. In the context of the invention, a parallel connection of the decision units is understood to mean a configuration such that the data stream can reach the individual decision units directly and does not have to flow successively through the decision units. Such an arrangement ensures that the data stream can be analyzed simultaneously by the existing decision units so the individual analysis statements can be created independently of one another. This has the advantage that, using simple means and in a cost-effective, a time between the start of analyzing the data stream and providing the analysis statements can be reduced manner.

Preferably, the first decision unit and/or the second decision unit comprise artificial intelligence. Particularly preferably, all decision units of the evaluation device, i.e. the first decision unit, the second decision unit, any third decision unit, and any further decision units, comprise artificial intelligence. Further preferably, the logic device also comprises artificial intelligence. In the context of the invention, an artificial intelligence is understood to mean, for example, the ability to perform independent machine learning. This has the advantage that, using simple means and in a cost-effective manner, a reliability of the analysis statements and thus of the detection evaluation is improved.

According to a third aspect of the invention, the object is achieved by a computer program product. The computer program product comprises instructions that cause a detection system according to the invention to carry out a method according to the invention.

The computer program product according to the invention has all the advantages that have already been described for a method according to the first aspect of the invention and for a detection system according to the second aspect of the invention. Accordingly, the computer program product according to the invention has the advantage over conventional computer program products in that, using simple means and in a cost-effective manner, a fast and reliable detection of an occupant or object in the interior of the motor vehicle is ensured. By instructing the decision units to use the data stream to create the first analysis statement and the second analysis statement, it is no longer necessary to store an overall detection image so the detection system requires considerably less memory than conventional detection systems. Furthermore, by creating analysis statements directly from the data stream, the time between the start of creating the analysis statements and generating a valid detection evaluation can be further reduced.

According to a fourth aspect of the invention, the object is achieved by a computer-readable medium. The computer-readable medium comprises a computer program product according to the invention. In other words, the computer program product is stored on the computer-readable medium. The computer-readable medium can be in the form of a microchip, hard disk, CD, DVD, or the like.

The computer-readable medium according to the invention has all the advantages that have already been described for a method according to the first aspect of the invention, for a detection system according to the second aspect of the invention, and for a computer program product according to the third aspect of the invention. Accordingly, the computer program product according to the invention has the advantage over conventional computer program products in that, using simple means and in a cost-effective manner, a fast and reliable detection of an occupant or object in the interior of the motor vehicle is ensured. By instructing the decision units to use the data stream to create the first analysis statement and the second analysis statement, it is no longer necessary to store an overall detection image, so the detection system requires considerably less memory than conventional detection systems. Furthermore, by creating analysis statements directly from the data stream, the time between the start of creating the analysis statements and generating a valid detection evaluation can be further reduced.

According to a fifth aspect of the invention, the object is achieved by a motor vehicle. The motor vehicle comprises a body and an interior that is delimited to the outside by the body. According to the invention, the motor vehicle comprises a detection system according to the invention. The UWB transmitting device and the UWB receiving device are preferably designed as elements of a UWB sensor device of the detection system. The UWB sensor device is preferably integrated into a headliner of the vehicle, preferably concealed from the interior by the headliner. Preferably, the UWB sensor device is arranged in the center of the vehicle with respect to a vehicle width. Further preferably, the UWB sensor device is arranged in such a way that two rows of seats of the motor vehicle can be sensed by the UWB sensor device, so that the method for operating a detection system can be carried out for all seats of these two rows of seats.

The motor vehicle according to the invention has all the advantages that have already been described for a method according to the first aspect of the invention, for a detection system according to the second aspect of the invention, for a computer program product according to the third aspect of the invention, and for a computer-readable medium according to the fourth aspect of the invention. Accordingly, the motor vehicle according to the invention has the advantage over conventional motor vehicles that, using simple means and in a cost-effective manner, a fast and reliable detection of an occupant or object in the interior of the motor vehicle is ensured. By instructing the decision units to use the data stream to create the first analysis statement and the second analysis statement, it is no longer necessary to store an overall detection image so the detection system requires considerably less memory than conventional detection systems. Furthermore, by creating analysis statements directly from the data stream, the time between the start of creating the analysis statements and generating a valid detection evaluation can be further reduced.

### BRIEF DESCRIPTION OF THE DRAWINGS

The invention is explained in more detail below with reference to the accompanying drawings. In the figures:

FIG. 1 is a schematic view of a preferred embodiment of a detection system according to the invention;

FIG. 2 is a schematic view of a preferred embodiment of a computer program product according to the invention;

FIG. 3 is a schematic view of a preferred embodiment of a computer-readable medium according to the invention;

FIG. 4 is a schematic side view of a preferred embodiment of a motor vehicle according to the invention; and

FIG. 5 is a schematic flow chart of a preferred embodiment of a method according to the invention.

### DETAILED DESCRIPTION OF THE CURRENT EMBODIMENT

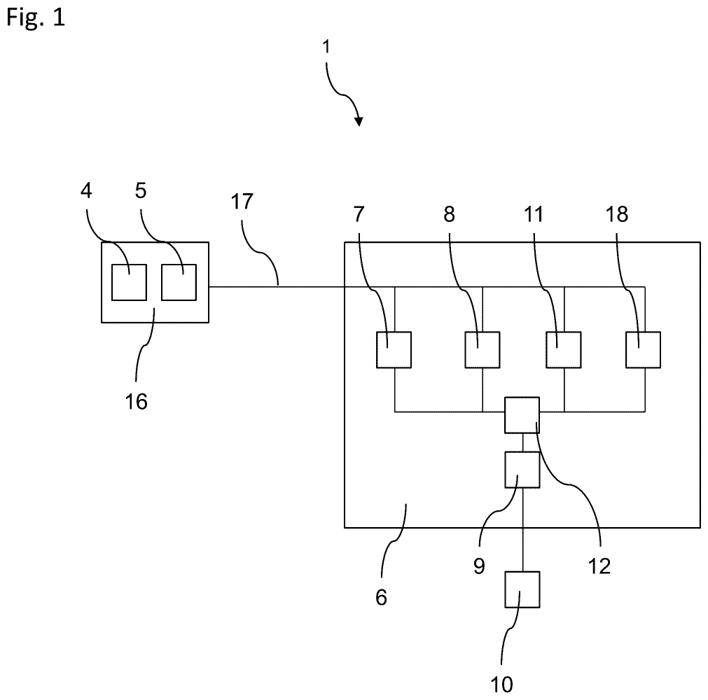

Elements with the same function and mode of operation are each provided with the same reference signs in FIG. 1 to FIG. 5.

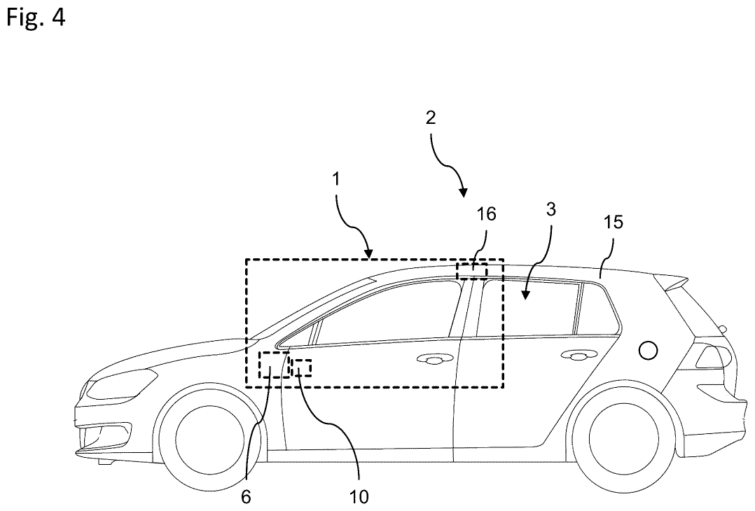

FIG. 1 schematically illustrates a preferred embodiment of detection system 1 according to the invention. The detection system 1 comprises a UWB sensor device 16 with a UWB transmitting device 4 and a UWB receiving device 5. The UWB transmitting device 4 is designed to transmit a scanning signal, for example into an interior 3 (see FIG. 4) of a motor vehicle 2 (see FIG. 4). The scanning signal can, for example, have a frequency between 1 GHz and 10 GHz, such as 2.5 GHZ, 5 GHZ, or the like. The sampling signal can also have several frequencies simultaneously and/or a frequency curve. The UWB receiving device 5 is designed to receive the scanning signal, which is reflected by walls, persons and/or objects, for example, and to forward the received scanning signal as a data stream via a CAN bus 17 of the detection system 1.

The detection system 1 further comprises an evaluation device 6 with a first decision unit 7, a second decision unit 8, a third decision unit 11, a fourth decision unit 18, a memory device 12, and a logic device 9. The first decision unit 7, second decision unit 8, third decision unit 11, and fourth decision unit 18 are coupled in parallel to the CAN bus 17 for simultaneously receiving the data stream generated by the UWB receiving device 5. According to the invention, a total of two or more decision units may be provided.

The first decision unit 7 is designed to create a first analysis statement by analyzing the data stream on the basis of a first decision criterion. The second decision unit 8 is designed to create a second analysis statement by analyzing the data stream on the basis of a second decision criterion that differs from the first decision criterion. The third decision unit 11 is designed to create a third analysis statement by analyzing the data stream on the basis of a third decision criterion that differs from the first decision criterion and the second decision criterion. The fourth decision unit 18 is designed to create a fourth analysis statement by analyzing the data stream on the basis of a fourth decision criterion that differs from the first decision criterion, the second decision criterion, and the third decision criterion. For this purpose, the decision units preferably comprise artificial intelligence.

The decision criteria and/or segments of the data stream and/or analysis statements can be stored in the memory device 12. Logic device 9 is designed to generate a detection evaluation by combining the first analysis statement with the second analysis statement, the third analysis statement, and the fourth analysis statement. Furthermore, logic device 9 is designed to cause an alarm transmitter 10 of the detection system 1 to issue an alarm if the detection evaluation satisfies a predefined detection criterion.

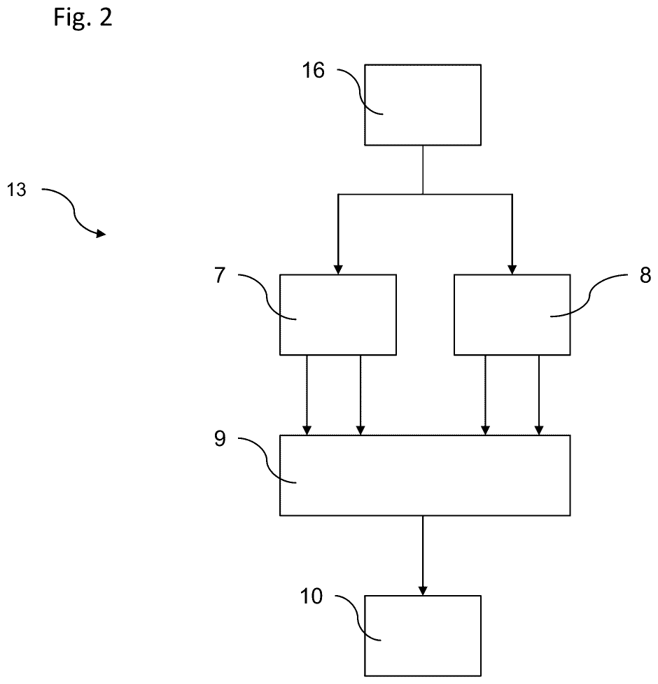

FIG. 2 schematically shows a preferred embodiment of a computer program product 13 according to the invention. Computer program product 13 comprises instructions for causing detection system 1 to perform a method according to the invention. Thus, the UWB sensor device 16 can be caused to send, receive, and forward the scanning signal as a data stream to the first decision unit 7 and the second decision unit 8. In addition, the first decision unit 7 and second decision unit 8 can be caused to analyze the data stream on the basis of the respective decision criteria, thus creating the respective analysis statements, and forwarding them to the memory device 12 or the logic device 9. As can be seen from the figure, the analysis statements are each designed as binary analysis statements. The logic device 9 can be caused by the computer program product 13 to generate a detection evaluation by combining the analysis statements and depending on the detection evaluation and a detection criterion, to cause the alarm transmitter 10 to output the alarm signal.

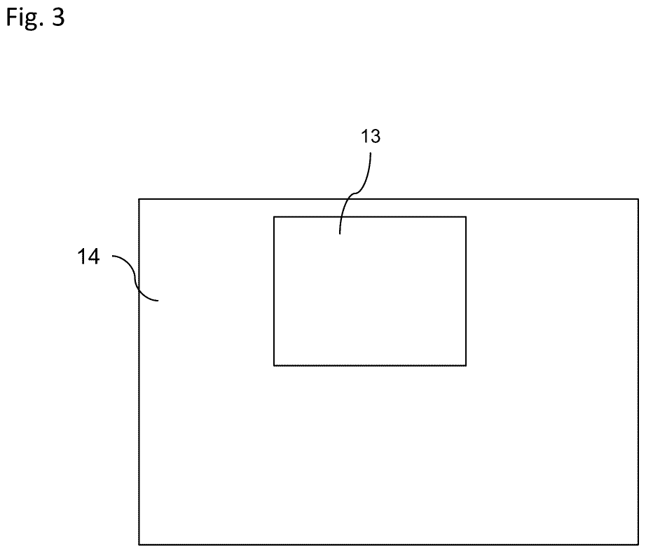

FIG. 3 schematically illustrates a preferred embodiment of a computer-readable medium 14 according to the invention. A computer program product 13 according to the invention is stored on the computer-readable medium 14.

FIG. 4 shows a schematic side view of a preferred embodiment of a motor vehicle 2 according to the invention. The motor vehicle 2 comprises a body 15, which forms an interior 3 of the motor vehicle 2. A UWB sensor device 16 of a detection system 1 according to the invention is arranged on a headliner of the interior 3. The detection system 1 further comprises an evaluation device 6, which is based on artificial intelligence and is coupled with the UWB sensor device 16 in a data-communicating manner, and an alarm transmitter 10 coupled with the evaluation device 6.

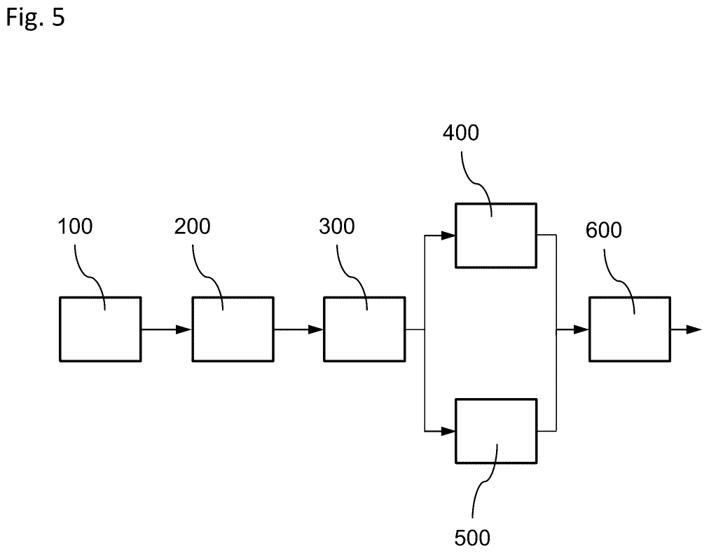

In FIG. 5, a preferred embodiment of a method according to the invention for operating a detection system 1 for detecting an occupant of a motor vehicle 2 is shown schematically in a flow chart. In a first method step 100, a UWB transmitting device 4 of the detection system 1 sends a scanning signal into an interior 3 of the motor vehicle 2. In a second method step 200, a UWB receiving device 5 of the detection system 1 receives the reflected scanning signal. In a third method step 300, the UWB receiving device 5 forwards the received scanning signal as a data stream to an evaluation device 6 of the detection system 1.

In a fourth method step 400, a first decision unit 7 of the evaluation device 6 creates a first analysis statement by analyzing the data stream on the basis of a first decision criterion. In a fifth method step 500, a second decision unit 8 of the evaluation device 6 creates a second analysis statement by analyzing the data stream on the basis of a second decision criterion. In a sixth method step 600, a logic device 9 of the evaluation device 6 generates a detection evaluation by combining the first analysis statement with the second analysis statement.

### LIST OF REFERENCE SIGNS

1 detection system
2 motor vehicle
3 interior
4 UWB transmitting device
5 UWB receiving device
6 evaluation device
7 first decision unit
8 second decision unit
9 logic device
10 alarm transmitter
11 third decision unit
12 memory device
13 computer program product
14 computer-readable medium
15 body
16 UWB sensor device
17 CAN bus
18 fourth decision unit
100 first method step
200 second method step
300 third method step
400 fourth method step
500 fifth method step
600 sixth method step

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for operating a detection system for detecting an occupant of a motor vehicle, the method comprising:
sending a scanning signal into an interior of the motor vehicle by an ultra-wideband (UWB) transmitting device of the detection system;
receiving the scanning signal by a UWB receiving device of the detection system;
forwarding the received scanning signal from the UWB receiving device as a data stream to an evaluation device of the detection system;
creating a first analysis statement at a first decision unit of the evaluation device by analyzing the data stream on the basis of a first decision criterion;
creating a second analysis statement at a second decision unit of the evaluation device by analyzing the data stream on the basis of a second decision criterion; and
generating a detection evaluation by a logic device of the evaluation device by combining the first analysis statement with the second analysis statement.

2. The method of claim 1, wherein the first analysis statement or the second analysis statement are binary analysis statements.

3. The method of claim 2, wherein the first analysis statement or the second analysis statement relates to the detection of a living being, the detection of a human being, or the detection of a child.

4. The method of claim 1, wherein an alarm is emitted by an alarm transmitter when the detection evaluation corresponds to a predefined detection result.

5. The method of claim 1, wherein the data stream is analyzed such that the scanning signal is analyzed segment by segment.

6. The method of claim 1, wherein analyzing the data stream is carried out continuously or intermittently.

7. The method of claim 1, wherein a third decision unit of the evaluation device creates a third analysis statement by analyzing the data stream on the basis of a third decision criterion, wherein the logic device generates the detection evaluation by combining the first analysis statement with the second analysis statement and the third analysis statement.

8. A detection system for detecting an occupant of a motor vehicle, comprising:
a UWB transmitting device for sending a scanning signal into an interior of the motor vehicle;
a UWB receiving device for receiving the scanning signal and forwarding the received scanning signal as a data stream; and
an evaluation device for receiving the data stream, wherein the evaluation device comprises:
a first decision unit for creating a first analysis statement from the data stream based on a first decision criterion,
a second decision unit for creating a second analysis statement from the data stream based on a second decision criterion, and
a logic device for generating a detection evaluation by combining the first analysis statement with the second analysis statement.

9. The detection system of claim 8, wherein the evaluation device further comprises a memory device for storing a segment of the data stream, wherein the memory device has a memory size of less than 100 kB.

10. The detection system of claim 8, wherein the evaluation device further comprises a memory device for storing analysis statements, wherein the memory device has a memory size of less than 100 kB.

11. The detection system of claim 8, wherein the first decision unit and the second decision unit are connected in parallel with respect to the data stream.

12. The detection system of claim 8, wherein the first decision unit and the second decision unit comprise artificial intelligence.

13. A computer program product that causes a detection system to perform the method of claim 1.

14. A computer-readable medium including the computer program product of claim 13.

15. A motor vehicle comprising:
a body;
an interior; and
the detection system of claim 8.
